(19) United States
(12) Patent Application Publication
(10) Pub. No.: US 2015/0208711 A1
(43) Pub. Date: Jul. 30, 2015

(54) INLINE MEAT TREATMENT PROCESS

(71) Applicant: GEA FOOD SOLUTIONS BAKEL B.V., Bakel (NL)

(72) Inventors: Willem Poos, 's-Hertogenbosch (NL); Stuart Barnacle, Ipswich Suffolk (GB)

(21) Appl. No.: 14/427,811

(22) PCT Filed: Sep. 12, 2013
(86) PCT No.: PCT/EP2013/068862

§ 371 Date: Mar. 12, 2015

(30) Foreign Application Priority Data
Sep. 14, 2012 (EP) 12184466.6

(51) Int. Cl. A23L 1/318

(52) U.S. Cl. CPC A23L 1/3182; A23L 1/3187; A23V 2002/00

(57) ABSTRACT

The present invention relates to an inline process for treating meat, i.e. to a process that is carried out on a production line where the meat travels down a line, having one step after another done to it. The speed of the movement of the meat during its travel along the line can be altered or maintained constant. The inline process for treating meat comprising the following steps:—injection of a marinade into the meat,—shaking of the meat,—heat treatment of the meat.

The present invention relates to a process for treating meat.

Meat treatment processes are well known from the state of the art. In many cases such a process starts by injecting a brine or the like into the meat, for example with needles. This marinated meat is subsequently often tumbled in order to distribute the brine in the meat. However, tumbling often harms delicate meat products and/or the productivity of such a process is limited because tumbling is a batch-process.

It was therefore the objective of the present invention to provide a process that does not comprise the deficiencies according to the state of the art.

The problem is solved with an inline process for treating meat comprising the following steps:
injection of a marinade into the meat,
shaking of the meat,
heat treatment of the meat.

The present invention relates to an inline process for treating meat, i.e. to a process that is carried out on a production line where the meat travels down a line, having one step after another done to it. The speed of the movement of the meat during its travel along the line can be altered or maintained constant.

The inventive concept has the advantage that no buffers, holding means or complex logistics are needed.

The meat that can be treated according to the inventive process can be any type of meat known by the person skilled in the art, for example pork, beef, lamb, poultry, particularly poultry with skin, preferably chicken wings and/or chicken legs and/or chicken breasts or fish.

According to the inventive process a marinade, for example a brine, is first of all injected into the meat. The marinade can be a watery solution which may comprise salt, spices, oil and/or vinegar. The injection is preferably carried out with an array of needles, which are inserted into the meat and the marinade is forced into the meat.

Subsequently, the meat is shaken. Shaken according to the present invention means that the meat is driven in at least one, preferably more directions, stopped and then reversed. The shaking is, for example caused by a vibration of a support, which carries the meat. Preferably, the motion of this support is chosen such, that the meat is not only shaken but also advanced in a certain direction. This support can be, for example a vibrating and/or oscillating table or a vibrating and/or oscillating belt. Preferably, the frequency, amplitude and/or the direction of the shaking is altered during the shaking step. Preferably, the orientation of the meat is altered during the shaking step. The meat is preferably flipped over during the shaking step, so that it is bared on different regions of its surface during the shaking. The shaking can be, for example, carried out by oscillating a transportation belt. In another preferred embodiment, the meat is put into a cage which is oscillated. The oscillation step can be a multistage process step, whereas in each stage the shaking parameters are at least partially different.

After the shaking, the meat is heat-treated. This heat treatment can be any heat treatment known to the person skilled in the art, for example frying, grilling or cooking, wherein cooking is preferred. The cooking is carried out with hot water, steam and/or with air and/or with heat transfer by radiation, conduction and/or natural or forced convection. The cooking can take place under a different pressure than ambient pressure.

According to a preferred embodiment, the inventive inline process comprises a holding step. However, this holding step is included in the line. Preferably, the meat is transported during the holding step. The holding step can be incorporated after the injection and prior to the shaking and/or after the shaking and prior to the heat treatment. Holding can be, for example, realized by additional transportation length and/or by an inline buffer.

In another preferred embodiment, the shaking and the transportation of the meat is carried out at least partially simultaneously. This saves line-length and process time. Preferably, the meat is supported on a surface, for example a table or a belt that carries out an approximately circular or ellipsoid movement. During this movement the meat is lifted from the surface and moved in one direction, while the surface moves, during the flight of the meat in the reverse direction. By this means, the meat is shaken and transported. Such devices are, for example so called vibrating table.

An unbalance motor (vibrator), for example, creates a circular movement of a table top which consequently vibrates in vertical and horizontal direction. A pendulum vibrator creates an almost linear (elliptical) movement of the table top. The direction of application of force is preferably variable adjustable. Hereby a specific transport effect on the table top can be achieved.

The inventive process has the following advantages:
no buffers needed
continuous supply of cooked products
less logistical effort
yield benefits compared to process without shaker
better brine distribution
protein activation
protein extraction
overall line yield improvement
better product appearance after cooking, no visual injection marks (needle marks)
better quality (blemish-less discoloration)

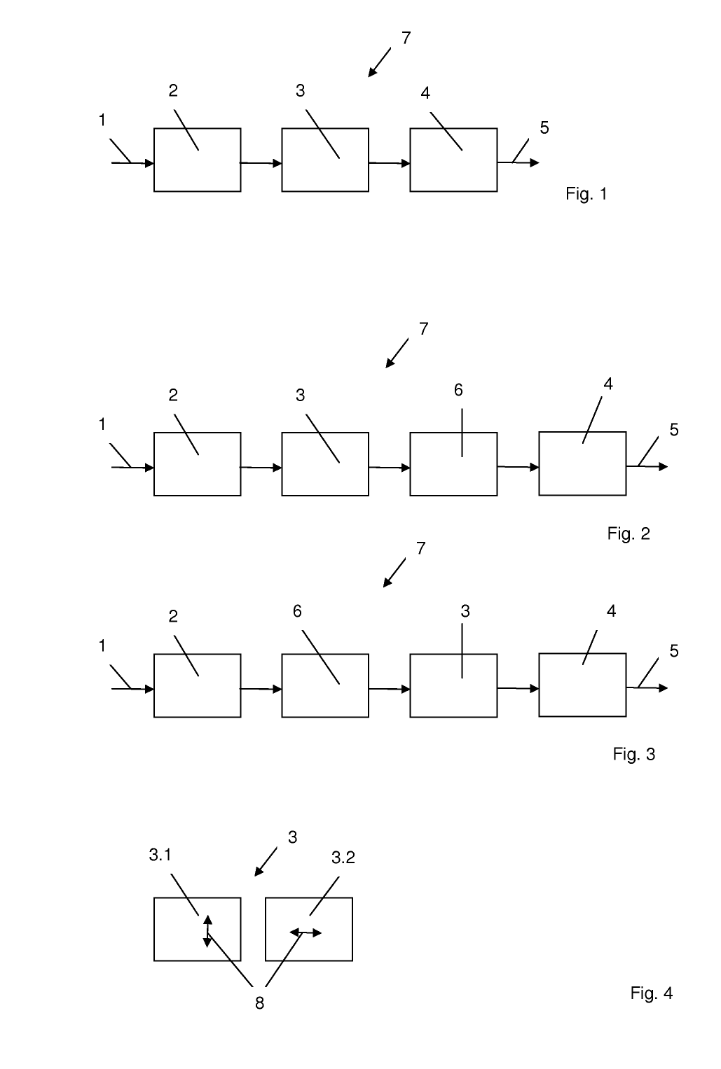

The invention is now explained according to FIGS. 1-4. These explanations do not limit the scope of protection of the present invention.

FIGS. 1-3 each show different embodiments of the present invention.

FIG. 4 shows an embodiment of the shaking step.

FIG. 1 shows a first embodiment of the inventive process. In this figure, a meat treatment line 7 is depicted. The meat is fed via an infeed 1 to the treatment line 7 and a marinade is injected into the meat in the injection step 2. This injection can be, for example, carried out by an array of needles that penetrate the meat at different locations. The pressurized marinade exits the needle while it travels through the meat and migrates at least partially into the meat. Subsequently, the marinated meat is shaken, i.e. subjected to vibrations which have a certain frequency and a certain amplitude, whereas the frequency and/or the amplitude and/or the direction of the vibration can be altered during the shaking step. The shaking improves the distribution of the marinade in the meat and/or supports the closure of the holes left by the needles. It is also possible to improve the tenderness of the meat by the shaking. Subsequently, a heat treatment device 4 is provided inline, in which the meat is heat-treated, preferably cooked. Finally, the injected, shaken and cooked meat exits the line at the outlet 5. Since the inventive process is an inline-process, the meat automatically and preferably continuously moves from one treatment step to the next. This reduces the logistics and a continuous stream of finished products can be achieved. The meat need not be stored during the treatment.

FIG. 2 shows another embodiment of the present invention. Essentially, reference can be made to FIG. 1 and the corresponding description. However, in the present case, a holding step 6 is included inline between the shaking step 3 and the heat treatment step 4. This holding step 6 can be realized, for example, by additional transportation lengths and/or by an inline buffer.

FIG. 3 shows yet another embodiment of the present invention. Again reference can be made to FIG. 1 and the corresponding description and to FIG. 2 and its description. However, in the present case, a holding step is included inline between the injection step 2 and the shaking step 3. Regarding the embodiment of the holding step, reference is made to the disclosure according to FIG. 2.

FIG. 4 shows an embodiment of the shaking step 3. In the present case, the shaking step comprises two stages in which the meat can be shaken separately and/or differently from each other. In the present case, the direction of the oscillation 8 differs. Both stages are arranged in the meat treatment line 7, whereas stage 3.1 is located upstream from stage 3.2.

### LIST OF REFERENCE SIGNS

1 infeed
2 injection
3 shaking
3.1 first stage
3.2 second stage
4 heat treatment, cooking
5 outfeed
6 holding, buffering, transporting
7 meat treatment line
8 direction of motion

What is claimed is:

1. An inline process for treating meat comprising the following steps:
injecting a marination-fluid into the meat,
shaking the meat, wherein the shaking is carried out by vibration of a support which carriers the meat,
heat treating the meat.

2. The inline process according to claim 1, wherein the heat treatment is cooking.

3. The inline process according to claim 1, wherein the process comprises a holding step.

4. The inline process according to claim 3, wherein the meat is transported during the step of holding.

5. The inline process according to claim 1, wherein the meat that is treated includes skin.

6. The inline process according to claim 1, wherein the shaking step comprises multiple stages.

7. The inline process according to claim 1, wherein during shaking the meat is moved in different directions.

8. The inline process according to claim 1, wherein during shaking, the meat is flipped over so that the meat is bared on different regions of its surface.

9. The inline process according to claim 1 wherein amplitude and/or frequency changes during the shaking step.

10. The inline process according to claim 1, wherein the shaking and the transportating steps of the meat are carried out at least partially simultaneously.

11. The inline process according to claim 10, wherein the meat is supported on a surface and the surface carries out an approximately circular or ellipsoid movement.

12. The inline process according to claim 2, wherein the process comprises a holding step.

13. The inline process according to claim 2, wherein the meat that is treated includes skin.

14. The inline process according to claim 2, wherein the shaking step comprises multiple stages,

15. The inline process according to claim 12, wherein the shaking step comprises multiple stages,

16. The inline process according to claim 2, wherein during shaking the meat is moved in different directions,

17. The inline process according to claim 15, wherein during shaking the meat is moved in different directions.

18. The inline process according to claim 3, wherein during shaking, the meat is flipped over so that the meat is bared on different regions of its surface.

19. The inline process according to claim 17, wherein during shaking, the meat is flipped over so that the meat is bared on different regions of its surface.

20. The inline process according to claim 19, wherein amplitude and/or frequency changes during the shaking step.
